(19) United States
(12) Patent Application Publication
(10) Pub. No.: US 2006/0107275 A1
(43) Pub. Date: May 18, 2006

(54) Disk drive

(76) Inventor: Hisateru Komatsu, Yamagata (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/165,333

(22) Filed: Jun. 24, 2005

(30) Foreign Application Priority Data
Nov. 17, 2004 (JP) P2004-333311

(51) Int. Cl. G11B 17/04

(52) U.S. Cl. 720/620

(57) ABSTRACT

A disk drive is formed by containing a disk driving mechanism in a housing. At least either opening 9 or recess 8 and a protrusion 10 are provided at the bottom of the housing 1 (bottom frame 2), and a plate 11 is attached so as to cover at least a part of the opening 9 or recess 8. The plate 11 is provided with an opening 12 in association with the protrusion 10 and is positioned by fitting the protrusion 10 into the opening 12 when attached. The plate 11 has an engaging piece 13 at the periphery thereof to be engaged with a slit 14 formed in a peripheral part at the bottom of the bottom frame 2, and the plate is thus attached and secured.

### BACKGROUND OF THE INVENTION

1. Field of the Invention

The present invention relates to a disk drive for writing and reading information in and from a flexible disk and, more particularly, to an improvement in a structure of a housing of the same.

2. Description of the Related Art

The spread of portable personal computers (so-called notebook personal computers) has resulted in pressing demand for reductions in the overall size, thickness, and weight of disk drives such as flexible disk drives (FDDs), and various improvements are therefore being sought in mechanical and structural components of such drives.

A disk drive is normally formed by housing a wiring board incorporating various processing circuits and mechanical components such as a spindle motor for driving a disk table or disk for rotation and a magnetic head, which is moved back and forth in the radial direction of a disk, in a frame (housing). In the case of an FDD, for example, information is written and read in and from the magnetic disk (flexible disk) by the magnetic head.

A frame is fabricated by processing a sheet metal having a thickness of about 1 mm or less. For disk drives incorporated in notebook personal computers as described above, frames have been developed, which has an overall thickness in the range of about 7 to 8 mm and in which a wiring board and mechanical components as described above are contained and securely mounted.

The thickness of sheet metals used as frames is apt to decrease with the thickness of disk drives, which has resulted in the tendency of reduction in the rigidity or strength of frames. Under the circumstance, there is demand for a method of improving the rigidity or strength of a frame effectively, and, for example, it has been proposed to bond a reinforcement plate to a frame (see JP-UM-A-7-43543 and JP-A-10-199208).

JP-UM-A-7-43543 discloses a disk drive comprising functional components such as a magnetic head, a wiring board, and a disk table and a frame in the form of a thin box which is open on the top side thereof to accommodate and hold those components, the disk drive further comprising a reinforcement plate which is a thin metal plate member having a thickness of 1 mm or less bonded to a bottom surface of the frame so as to cover one half or more of the area of the bottom surface. Bonding a reinforcement plate to the bottom surface of a frame makes the entire frame more resistant to flexure than securing a reinforcement material to other parts of the frame or reinforcing the frame by a special treatment, which makes it possible to improve the rigidity or strength of the frame in a reasonable and effective way and at a low cost while keeping the thickness of the entire frame as small as possible.

JP-A-10-199208 discloses a disk drive for recording and reproduction of information in and from a disk including a frame in the form of a thin box which is open on the top side thereof and functional components housed and held in the frame such as a magnetic head, wiring board, and disk table, the frame being also constituted by a sheet metal having a relatively small thickness, a thin reinforcement plate being applied to a lower surface of the bottom of the frame. According to the invention disclosed in Patent Document 2, the application of the reinforcement plate again makes it possible to make the disk drive lightweight and to provide it at a low cost without any reduction in the strength and shock resistance.

In a frame of a disk drive as described above, a recess or opening or a protrusion is provided, in particular, at the bottom of the frame because of a need for accommodating the shapes and sizes of mechanical components housed therein or the necessity of an adjusting mechanism. Such features may degrade the appearance of the drive, may reduce operability in mounting the disk drive, and may allow dust to enter, which can result in a reduction of the value of the disk drive as a merchandize.

For example, it will be advantageous to bond a reinforcement plate to the frame according to the inventions disclosed in Patent Documents 1 and 2 when it is required only to close the recess or opening. However, it is difficult to adapt a reinforcement plate as disclosed in Patent Document 1 and 2 to a situation in which a protrusion is formed at the bottom of the frame. The reinforcement plate in the invention disclosed in Patent Document 1 is bonded using spot welding, and the reinforcement plate in the invention disclosed in Patent Document 2 is applied using an adhesive. A reinforcement plate bonded using such methods cannot be removed, which disables operations such as adjusting functional components through an adjustment hole to be performed by removing the plate as occasions demand. Further, according to the inventions disclosed in Patent Documents 1 and 2, there is no mechanism for positioning a reinforcement plate when the plate is bonded. Thus, operability may be reduced, and there may be variation in the position and direction in which the plate is mounted.

### SUMMARY OF THE INVENTION

The invention is proposed to solve such problems. Specifically, it is an object of the invention to provide a disk drive in which an opening or recess at the bottom of a housing can be closed even when a protrusion is formed there and in which a plate can be positioned when it is mounted. It is another object of the invention to provide a disk drive in which a plate can be easily attached to a housing and can be detached as occasions demand.

In order to achieve the objects, the invention provides a disk drive formed by containing a disk driving mechanism in a housing, characterized in that it comprises at least either opening or recess and a protrusion provided at the bottom of the housing and a plate attached to the housing so as to cover at least a part of the opening or recess provided at the bottom of the housing and in that the plate is provided with an opening in association with the protrusion and is positioned by fitting the protrusion into the opening when attached.

In the disk drive according to the invention, since the plate is provided with the opening which is associated with the protrusion provided at the bottom of the housing, the protrusion does not hinder the bonding of the plate. The protrusion also serves as a positioning section by being fitted into the opening, and the plate can therefore be accurately positioned when attached, which eliminates any variation in the position and direction of the attachment of the plate. Further, since the opening provided on the plate is closed by the protrusion, the flatness of the bottom of the disk drive is maintained, which keeps the appearance of the disk drive preferable, improves operability in mounting the disk drive, and prevents dust from entering the same.

A disk drive according to the invention is characterized in that the plate has an engaging piece at the periphery thereof to be engaged with a slit formed in a peripheral part at the bottom of the housing. The plate can be detachably attached to the housing by attaching it to the housing through engagement of the engaging piece, and the plate can be removed as occasions demand to allow various adjusting operations to be performed through an adjustment hole. The plate can be attached only by engaging the engaging piece, and no complicated operation such as welding or bonding is required.

In the disk drive according to the invention, even when a protrusion is formed at the bottom of the housing, an opening or recess can be closed while clearing the protrusion. In addition, the plate can be positioned when it is attached. In the disk drive according to the invention, the plate can be easily attached to the housing and can be made detachable as occasions demand.

### BRIEF DESCRIPTION OF THE DRAWINGS

FIG. 1 is an exploded perspective view of a disk drive employing the invention showing an example of a configuration of the same, the view showing the drive with a plate thereof removed.

FIG. 2 is perspective view of the drive which is shown with the plate attached thereto.

### DESCRIPTION OF THE PREFERRED EMBODIMENTS

A specific embodiment of a disk drive employing the invention will now be described with reference to the drawings.

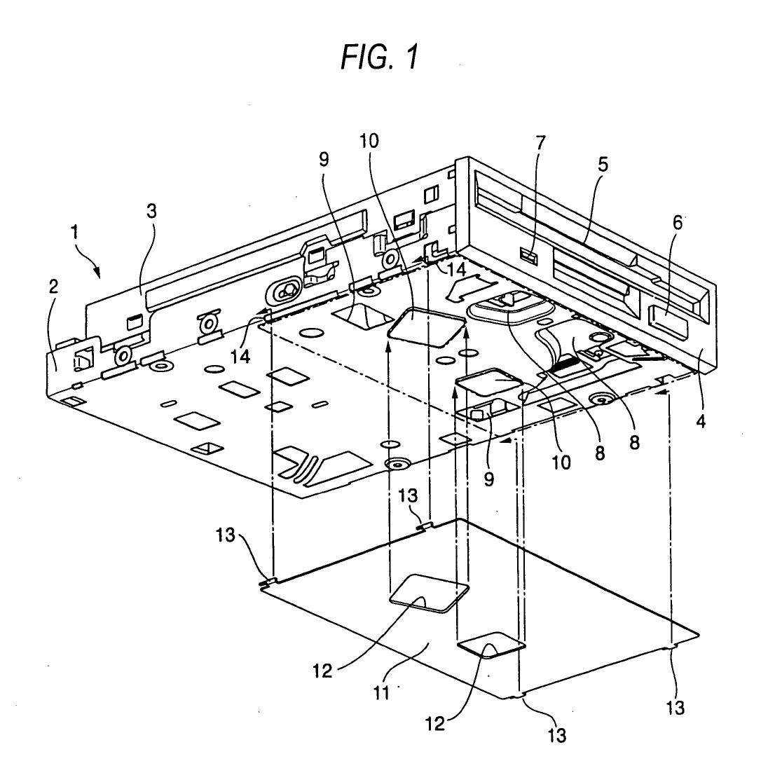

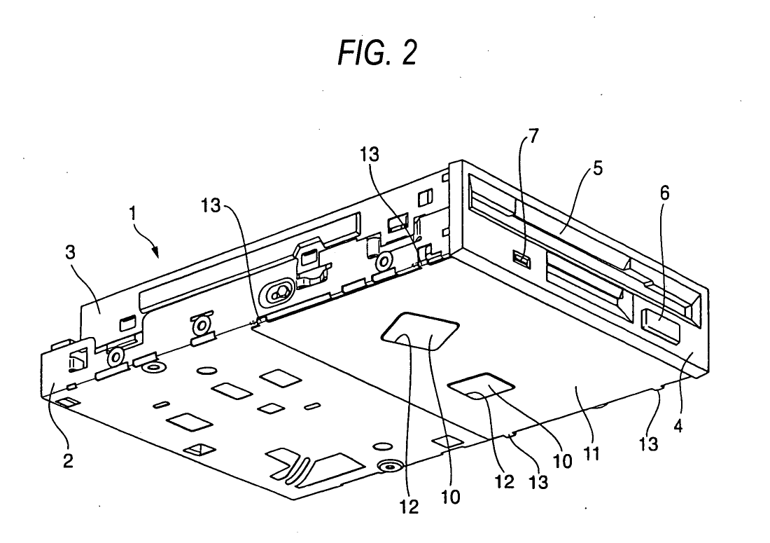

FIGS. 1 and 2 show an example of a configuration of the disk drive employing the invention. FIG. 1 shows the drive with a plate removed from the same, and FIG. 2 shows the drive with the plate attached. As shown in FIGS. 1 and 2, the disk drive of the present embodiment is formed by housing a wiring board incorporating various processing circuits and mechanical components constituting disk driving mechanisms such as a spindle motor for driving a disk table or disk for rotation and a magnetic head, which is moved back and forth in the radial direction of a disk, in a housing 1 made of metal and securing the components in predetermined positions. The housing 1 is constituted by a bottom frame 2 and a top frame 3 which are formed by bending a metal plate such as an aluminum plate or steel plate, and a top surface, side surfaces, and a bottom surface of the housing 1 are formed by combining the top and bottom frames. On a front face of the housing 1 formed by the bottom frame 2 and the top frame 3, a front panel 4 is attached so as to close an opening at the front face.

The front panel 4 is provided with a disk insertion hole 5 through which a disk (a flexible disk in the present embodiment) is inserted and removed, an operation button 6 for enabling an operation of removing a flexible disk which has been inserted, and an indicator lamp 7 indicating states of insertion of a disk. When a disk is inserted, the operation button 6 protrudes, and the indicator lamp 7 is turned on. To remove the disk, an ejecting operation is performed by pressing the operation button 6.

The bottom frame 2 forming a part of the housing 1 is provided with recesses 8, openings 9, and protrusions 10 which are provided in accordance with the structures and sizes of the mechanical components housed and which are alternatively provided to allow adjustments. For example, in order to accommodate a mechanical component which is insufficient in satisfying the need for reducing the thickness of the housing 1, a protrusion 10 is provided at the bottom frame 2, and the component is contained in a space expanded accordingly. An adjustment holes is also formed as an opening 9 in association with a component such as a magnetic head which must be adjusted. Alternatively, a hole to accept a driving shaft is formed as an opening 9.

When the recesses 8 and openings 9 are formed at the bottom of the housing 1 (bottom frame 2) as described above, the appearance of the drive can be degraded; smooth mounting of the disk drive may be hindered; and dust may be allowed to enter the drive to cause troubles therein. Under the circumstance, a plate 11 is attached so as to close the recesses 8 and openings 9 of the bottom frame 2 in the present embodiment.

Although the plate 11 is formed of a metal plate similarly to the bottom frame 2 forming a part of the housing 1, the invention is not limited to the same, and the plate may be formed of other materials. In the present embodiment, the plate 11 is attached in a range substantially covering one half of the bottom frame so as to cover the recesses 8 and openings 9 which are relatively large. However, this is not limiting the invention, and the plate may be, for example, in a size substantially equal to the bottom surface of the bottom frame 2, such that the bottom surface of the bottom frame 2 is entirely covered.

Further, the plate 11 is formed with openings 12 which are in association with the protrusions 10 provided at the bottom frame 2. The shape of the openings 12 is substantially the same as the shape of the protrusions 10. The plate 11 is attached such that the shape of the openings 12 conforms to the shape of the protrusions 10, which allows the attaching direction of the plate 11 to be automatically recognized. The openings 12 and the protrusions 10 serve as a positioning mechanism when the plate 11 is attached. Specifically, when the plate 11 is attached to the bottom frame 2, the protrusions 10 of the bottom frame 2 are fitted into the openings 12 provided at the plate 11.

As a result, the plate 11 is attached to the bottom frame 2 while being properly positioned, and no variation therefore occurs in the attaching direction and the attaching position of the plate.

The plate 11 is attached to the bottom frame 2 also using engaging pieces 13. As shown in FIG. 1, engaging pieces 13 are formed in four locations on two edges of the plate 11 in association with four corners of the plate 11. The engaging pieces 13 are so-called engaging claws for holding the metal plate constituting the bottom frame 2 between pin-like portions of the same and the periphery of the plate 11.

Therefore, when the plate 11 is attached, the engaging pieces 13 are inserted into slits 14 provided at peripheral sections (corner sections) at the bottom of the bottom frame 2 and slid in a predetermined direction. Thus, the metal plate constituting the bottom frame 2 is held by the engaging pieces 13, and the plate 11 is thus attached and secured to the frame. After the plate 11 is thus attached, it can be removed by sliding it in the direction opposite to that described above to disengage the engaging pieces 13.

As thus described, in the disk drive of the present embodiment, the plate 11 can be easily attached and secured without using methods such as welding and bonding. Further, the plate 11 is detachable, and it is therefore possible to remove the plate as occasions demand to allow operations such as adjustment to be performed.

What is claimed is:

1. A disk drive, comprising:
a housing, containing a disk driving mechanism;
a protrusion, protruded from a bottom surface of the housing; and
a plate, formed with an opening and attached to the housing so as to cover a part of the bottom;
wherein the plate is positioned by fitting the protrusion into the opening.

2. The disk drive according to claim 1, wherein the plate has an engaging piece to be engaged with a slit formed in a peripheral part at the bottom of the housing.

3. The disk drive according to claim 2, wherein a disk driven by the disk drive is a flexible disk.
